(19) United States
(12) Patent Application Publication
(10) Pub. No.: US 2012/0079449 A1
(43) Pub. Date: Mar. 29, 2012

(54) SYSTEMS AND METHODS FOR FACILITATING VISUAL MANAGEMENT OF AN AGILE DEVELOPMENT PROCESS

(75) Inventors: Kristen Altman Sanderson, Melbourne, FL (US); Michael Todd Swanson, Melbourne, FL (US)

(73) Assignee: General Electric Company, Schenectady, NY (US)

(21) Appl. No.: 12/893,110

(22) Filed: Sep. 29, 2010

(51) Int. Cl. G06F 9/44

(52) U.S. Cl. 717/102

(57) ABSTRACT

Systems and methods for facilitating visual management of an agile development process are provided. A plurality of features to be completed during an Agile development process for a software product may be identified. A respective number of predetermined time units to be allocated for development of each feature may be determined. Based at least in part upon the determination of predetermined time units, each of the features may be assigned to a respective development team included in a plurality of development teams. An illustration of the plurality of features assigned to the plurality of development teams may be generated. The illustration may include, for each feature, a respective identifier of the feature and a respective indication of the predetermined time units allocated to the feature. The generated illustration may be output for display to a user.

### FIELD OF THE INVENTION

Embodiments of the invention relate generally to software development and more specifically to the visual management of an Agile software development process.

### BACKGROUND OF THE INVENTION

Agile software development is a conceptual framework for software development and software engineering. In a typical Agile development process, software is developed in relatively short units of time (e.g., one week, two weeks, one month), referred to as an iteration. Each iteration typically relates to a unit or component of the software project, and each iteration may include planning, requirements analysis, design, coding, testing, and documentation. Depending on the complexity of the software project under development, an iteration may or may not add enough functionality to warrant an external release, but a typical goal is to have a releasable product that has additional or modified functionality at the end of each iteration. A project manager or management team typically evaluates the software at the completion of each iteration, and requests changes for the next iteration. In this regard, the working product can be evaluated and altered as it is developed.

During a typical Agile development process, components of a software project are assigned to various design teams or programming teams. Project managers are responsible for tracking the work that is completed by each design team as well as the completion of the various components or features of the software product. However, once development begins, the project managers often find it difficult to manage the workflow that is assigned to each development team. Additionally, the project managers may have difficultly in managing the assignment of various components to the development teams. Accordingly, improved systems and methods for facilitating visual management of an Agile development process are desirable.

### BRIEF DESCRIPTION OF THE INVENTION

Some or all of the above needs and/or problems may be addressed by certain embodiments of the invention. Embodiments of the invention may include systems and methods for facilitating visual management of an Agile development process. According to one embodiment of the invention, there is disclosed a method for displaying a set of features to be completed during development of a software product. A plurality of features to be completed during an Agile development process for the software product may be identified. A respective number of predetermined time units to be allocated for development of each feature may be determined. Based at least in part upon the determination of predetermined time units, each of the features may be assigned to a respective development team included in a plurality of development teams. An illustration of the plurality of features assigned to the plurality of development teams may be generated. The illustration may include, for each feature, a respective identifier of the feature and a respective indication of the predetermined time units allocated to the feature. The generated illustration may be output for display to a user. In certain embodiments, the above operations may be performed by a computing system that includes any number of computers and/or processing components.

According to another embodiment of the invention, there is disclosed a system for displaying a set of features to be completed during development of a software product. The system may include at least one memory and at least one processor. The at least one memory may be configured to store computer-executable instructions. The at least one processor may be configured to access the at least one memory and execute the computer-executable instructions to: identify a plurality of features to be completed during an Agile development process for the software product; determine a respective number of predetermined time units to be allocated for development of each feature; assign, based at least in part upon the determination of predetermined time units, each of the features to a respective development team included in a plurality of development teams; generate an illustration of the plurality of features assigned to the plurality of development teams, the illustration comprising, for each feature, a respective identifier of the feature and a respective indication of the predetermined time units allocated to the feature; and direct the output of the generated illustration for display to a user.

Additional systems, methods, apparatus, features, and aspects are realized through the techniques of various embodiments of the invention. Other embodiments and aspects of the invention are described in detail herein and are considered a part of the claimed invention. Other embodiments and aspects can be understood with reference to the description and the drawings.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram of one example control system that may be utilized to facilitate visual management of an Agile development process, according to an illustrative embodiment of the invention.

FIGS. 2A-2B illustrate flow charts of one example method for facilitating the . visual management of an Agile development process, according to an illustrative embodiment of the invention.

FIG. 3 is an example illustration that may be generated in accordance with various embodiments of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are systems and methods for facilitating the visual management of an agile development process. In accordance with various example embodiments of the invention, a plurality of features to be completed during an Agile development process for the software product may be identified. Each of the features may be, for example, a component or module of the software product. Once the plurality of features have been identified, a respective number of predetermined time units or iterations to be allocated for development of each feature may be determined. A wide variety of suitable techniques may be utilized to determine a number of predetermined time units to allocate to each feature. For example, a velocity (e.g., productivity rate, etc.) associated with one or more development teams may be determined, and the number of predetermined time units allocated to each feature may be determined based upon the velocity. In certain embodiments, an average velocity associated with a plurality of development teams may be determined and utilized.

Based at least in part upon the determination of predetermined time units, each of the features may be assigned to a respective development team included in a plurality of development teams. As desired, a wide variety of prioritization information associated with the features may be taken into consideration or utilized during the assignment of the features. Additionally, as desired, any number of work streams or pipelines may be associated with each of the development teams, and features may be assigned to particular work streams. For example, a relatively high priority feature may be assigned to a primary work stream or pipeline of a development team, and a relatively low priority feature may be assigned to a secondary work stream or pipeline of the development team. Additionally, if multiple work streams are associated with a development team, percentages of the development team's workload may be identified and/or assigned to each of the work streams. These percentages may be taken into consideration when features are assigned to the work streams and/or when the amount of time allocated to the feature is identified. For example, if it is determined that a feature will take approximately four predetermined time units to complete when a development team dedicates all of its available time to the feature, then it may be determined that the feature will take approximately eight predetermined time units to complete when a development team dedicates approximately half of its available time to the feature.

Once the plurality of features have been assigned to the plurality of development teams, an illustration of the assigned plurality of features may be generated. The illustration may include a wide variety of information as desired in various embodiments of the invention. For example, a respective feature identifier and an indication of the allocated time units may be illustrated for each feature. Additionally, the illustration may depict the development team and/or work stream or pipeline to which each feature is assigned. As desired, the illustration may additionally include indications of one or more release dates associated with the software product and/or an indication of a current point in time within the development process. As a result of generating an illustration of the features and assignment of features associated with a software development project, the development of the various features may be managed and tracked at a relatively high level by one or more project managers or supervisors.

Once the illustration has been generated, the illustration may be output for display to a user. For example, the illustration may be output by a computing system to an associated display device, such as a monitor. As another example, the illustration may be communicated via any number of suitable networks to one or more workstations for display to any number of users. In certain embodiments of the invention, the generated illustration may be an interactive illustration. In other words, user input associated with the illustration and/or suggested modification to the illustration may be received. For example, a user request to modify a designated feature may be received and processed. A wide variety of different types of user requests may be received as desired in certain embodiments of the invention, such as a request to modify a priority associated with a designated feature (e.g., a request to develop a feature at an earlier point in time), a request to modify the number of time units associated with a designated feature, or a request to assign a designated feature to another development team and/or work stream. Once a user request is received, the user request may be processed, and information associated with the designated feature may be modified. The illustration may then be modified to reflect the modification of the designated feature, and the modified illustration may be output for display to the user. Additionally, in certain embodiments, one or more additional features other than the designated feature may be dynamically modified based upon the modification of the designated feature.

Various embodiments of the invention may include one or more special purpose computers, systems, and/or particular machines that facilitate the visual management of an Agile software development process. A special purpose computer or particular machine may include a wide variety of different software modules and/or computer-implemented or computer-executable instructions as desired in various embodiments. As explained in greater detail below, in certain embodiments, these various software components may be utilized to facilitate the generation of one or more interactive illustrations or displays that facilitate the management of an Agile software development process.

Certain embodiments of the invention described herein may have the technical effect of facilitating the visual management of an Agile software development process. Additionally, certain embodiments of the invention may have the technical effect of assigning features or components of a software development project to a plurality of design teams and generating one or more interactive illustrations associated with the assigned features or components. In this regard, the development of the various features of a software development project may be managed and tracked at a relatively high level by one or more project managers or supervisors.

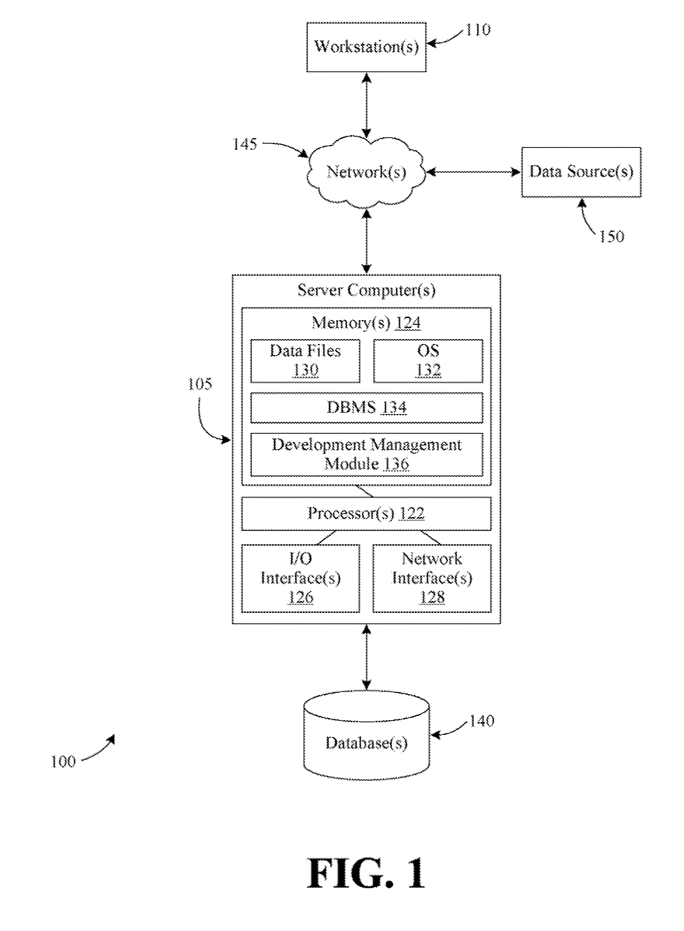

FIG. 1 is a block diagram of one example system 100 that may be utilized in accordance with various embodiments of the invention to facilitate the visual management of an Agile development process. With reference to FIG. 1, the system 100 may include one or more server computers 105 that are configured to generate one or more illustrations and/or displays that facilitate management of software development. In one example embodiment, a server computer 105 may obtain data associated with the various features or components to be completed during an Agile development process. The server computer 105 may then assign the various features or components to a plurality of development teams or programming teams. Based upon the assignment, the server computer 105 may generate an interactive pipeline illustration of the various features of a software product under development. The server computer 105 may output the illustration for display to one or more users via an associated display device (e.g., a monitor, etc.) and/or via one or more workstations 110. Additionally, the server computer 105 may be configured to modify the pipeline illustrations in accordance with user input received from the one or more users.

Any number of server computers 105 may be provided as desired in various embodiments of the invention. A server computer 105 may include any number of processor-driven devices that facilitate the visual management of an Agile development process. For example, a server computer 105 may include any number of special purpose computers or particular machines, application-specific circuits, programmable logic controllers (PLC), microcontrollers, personal computers, minicomputers, mainframe computers, supercomputers, and the like. In certain embodiments, the operations of the server computer 105 may be controlled by computer-executed or computer-implemented instructions that are executed by one or more processors associated with the server computer 105. The instructions may be embodied in one or more software components as desired in various embodiments of the invention. The execution of the instructions may form a special purpose computer or other particular machine that is operable to facilitate the visual management of an Agile development process. The one or more processors may be incorporated into the server computer 105 and/or be in communication with the server computer 105 via one or more suitable networks. Additionally, in certain embodiments of the invention, the operations and/or control of the server computer 105 may be distributed among several processing components.

A server computer 105 may include one or more processors 122, one or more memory devices 124, one or more input/output (“I/O”) interfaces 126, and/or one or more network interfaces 128. The one or more memory devices 124 may be any suitable memory devices, for example, caches, read-only memory devices, random access memory devices, magnetic storage devices, etc. The one or more memory devices 124 may store data, executable instructions, and/or various program modules utilized by the server computer, such as data files 130 an operating system (“OS”) 132, a database management system (“DBMS”) 134, and/or a development management module 136. The data files 130 may include any suitable data associated with the operation of the server computer 105 and/or the generation of one or more displays that facilitate the visual management of a software development process, for example, formatting parameters for an illustration, information associated with development teams, information associated with features or components of the software product, etc. Additionally, the one or more memory devices 130 may store any number of logical memory constructs, such as one or more database 140. The one or more databases 140 may be operable to store a wide variety of information associated with the generation of an illustration that facilitates the visual management of a software development process. For example, the one or more databases 140 may store requirements information associated with a software product (e.g., information associated with features or components of the software product, information associated with estimated workloads for various features or components, etc.) and/or various historical information, such as historical development information that may be utilized to determine requirements information for a software product and/or velocity information for one or more development teams.

The OS 132 may include executable instructions and/or program modules that facilitate and/or control the general operation of the server computer 105. For example, the OS 132 may facilitate the execution of other software programs and/or program modules by the processors 122. The DBMS 134 may facilitate the management of information that is stored in the one or more databases 140, as well as the reading and/or writing of information to the databases 140.

The development management module 136 may be a suitable module that is operable to facilitate the visual management of an Agile software development process. In operation, the development management module 136 may generate an illustration of the various features and/or components of a software development project that are under development and assigned to one or more project development teams. In this regard, the development of the various features may be managed and tracked at a relatively high level by one or more project managers or supervisors. Additionally, development priorities and scheduled releases may be managed.

In one example embodiment of the invention, the development management module 136 may identify a set or plurality of features to be completed during the Agile development of a software product. The features may be components of the software product that is under development. In certain embodiments, one or more features may be identified based upon a specification or other development data for the software product. In other embodiments, one or more features may be identified based upon historical data associated with previous software development projects. In yet other embodiments, one or more features may be specified by a user and identified from user input.

Once the features or components have been identified, the development management module 136 may determine a number of predetermined time units or time iterations to be allocated to each feature. The number of allocated time units for a feature may reflect an estimated amount of time for development (e.g., planning, requirements analysis, design, coding, testing, and/or documentation) of the feature. A wide variety of different time units and/or time iterations may be utilized as desired in various embodiments of the invention, such as a time unit of one week, two weeks, one month, etc. Additionally, a wide variety of suitable methods and/or techniques may be utilized to facilitate the allocation of time units to the features. For example, an estimated workload (e.g., man hours, etc.) and/or other requirements data that will likely be required for development of a feature may be identified based upon user input, specification data, and/or historical information (e.g., information associated with the development of similar features, information associated with the development of previous iterations of the feature, etc.). Additionally, an estimated velocity (e.g., productivity metric, throughput metric, etc.) associated with one or more development teams and/or work flows or work pipelines, such as an average velocity associated with a plurality of development teams or a velocity for a work flow pipeline, may be identified, received, and/or calculated. Based upon the requirements information for a feature and the velocity, a number of time units to be allocated to the development of the feature may be determined. As an alternative to the development management module 136 calculating a number of time units to be allocated to a feature, a number of time units for a feature may be specified in data accessed by and/or received by the development management module 136, such as data stored in the databases 140 and/or user input data.

The development management module 136 may additionally identify any number of available development teams and/or work streams or work pipelines associated with the development teams. Each development team may include any number of individuals (e.g., approximately 3 to approximately 7 individuals, etc.) that may be assigned to development one or more features associated with the software product. As desired, each development team may be associated with any number of work streams or pipelines. As one example, a primary work pipeline, a secondary work pipeline, and/or a support pipeline may be associated with a development team. Additionally, a wide variety of techniques may be utilized to allocate a development teams available time between the work streams. For example, approximately sixty percent (60%) of a development team's time may be allocated to the primary work pipeline, approximately twenty percent (20%) of the development team's time may be allocated to the secondary work pipeline, and approximately twenty percent (20%) of the development team's time may be allocated to the support pipeline.

According to an aspect of the invention, the development management module 136 may assign the plurality of features or the set of features to the development teams and/or to the various work streams. A wide variety of suitable techniques and/or methods may be utilized to assign the features to development teams and/or work streams. For example, priority information associated with the features may be identified, and the features may be assigned based at least in part on the priority information. In this regard, relatively high priority features may be assigned to primary work streams and/or to available development teams, and relatively low priority features may be assigned to secondary work streams and/or assigned to be completed at a later point in time than higher priority features. Additionally, order information associated with the completion of features may be taken into consideration. For example, a feature that is a prerequisite to another feature may be assigned to be completed prior to the start of the other feature. As another example of assigning features, a user may manually assign features.

As desired, the number of predetermined time units that are allocated or assigned to a feature may be adjusted or determined based upon the development team or work stream to which the feature is assigned. In other words, a velocity of a development team and/or the percentage of a development team's available time that is dedicated to the feature may be taken into consideration. For example, a feature may be allocated two predetermined time units if it is assigned to a work stream to which all of a development team's available time is dedicated. However, the feature may be allocated four predetermined time units if it is assigned to a work stream to which half of the development teams available time is dedicated. In addition to adjusting predetermined time units based upon the work streams to which features are assigned, the available work streams and assigned percentages of development team time may be taken into consideration during the assignment of features to development teams and/or work streams.

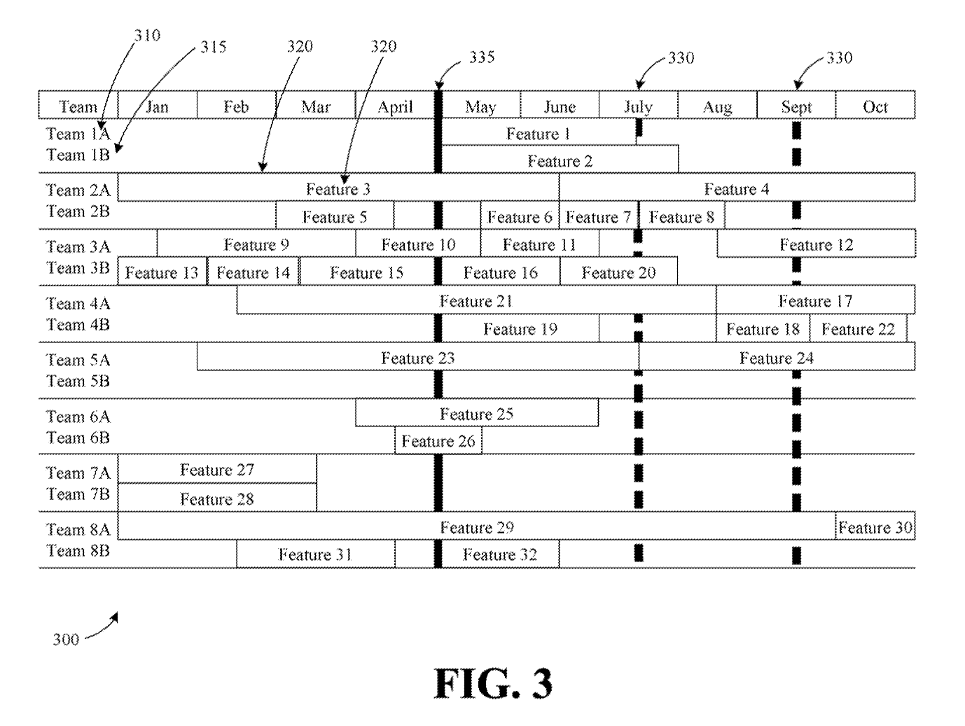

In order to facilitate the visual management of a software development project, the development management module 136 may generate a pipeline illustration of the features that are assigned to the one or more development teams. The illustration may include a wide variety of suitable information as desired in various embodiments of the invention, such as identifying information for each of the features, assignment information indicating the development teams and/or work streams to which the features are assigned, indications of the number of time units allocated to each of the features, projected release dates, an indication of a current point of time in the development process, billing information and/or cost code information associated with the features, etc. The illustration may provide a relatively high level overview of the features that have been developed, are under development, and/or that are scheduled for development. In this regard, the illustration may facilitate the management of the Agile development process for the software product. One example of an illustration that may be generated by the development management module 136 is described in greater detail below with reference to FIG. 3. Once an illustration has been generated, the development management-module 136 may direct the output of the generated illustration for display to one or more users, such as display via one or more associated monitors or display devices and/or display via one or more workstations 110 in network communication with the server computer 105.

In certain embodiments of the invention, a generated illustration may be an interactive illustration that facilitates the receipt of user input, such as user input to modify one or more features associated with the illustrations. A wide variety of different types of user input may be received as desired in various embodiments of the invention, such as a user request to modify a priority associated with a designated feature (e.g., a request to develop a feature at an earlier point in time), a user request to modify the number of time units associated with a designated feature, or a user request to assign a designated feature to another development team and/or work stream. A user request may be received by the development management module 136 and processed in order to modify the illustration. For example, the development management module 136 may modify a designated feature in association with a received user request, and the development management module 136 may update or modify the illustration to reflect the modification of the designated feature. Additionally, in certain embodiments, one or more additional features other than the designated feature may be dynamically modified based upon the modification of the designated feature. For example, if a feature is assigned to a different development team, the work streams of the development teams may be updated to reflect the reassignment. Once the illustration has been modified, the development management module 136 may output the modified illustration for display to any number of users.

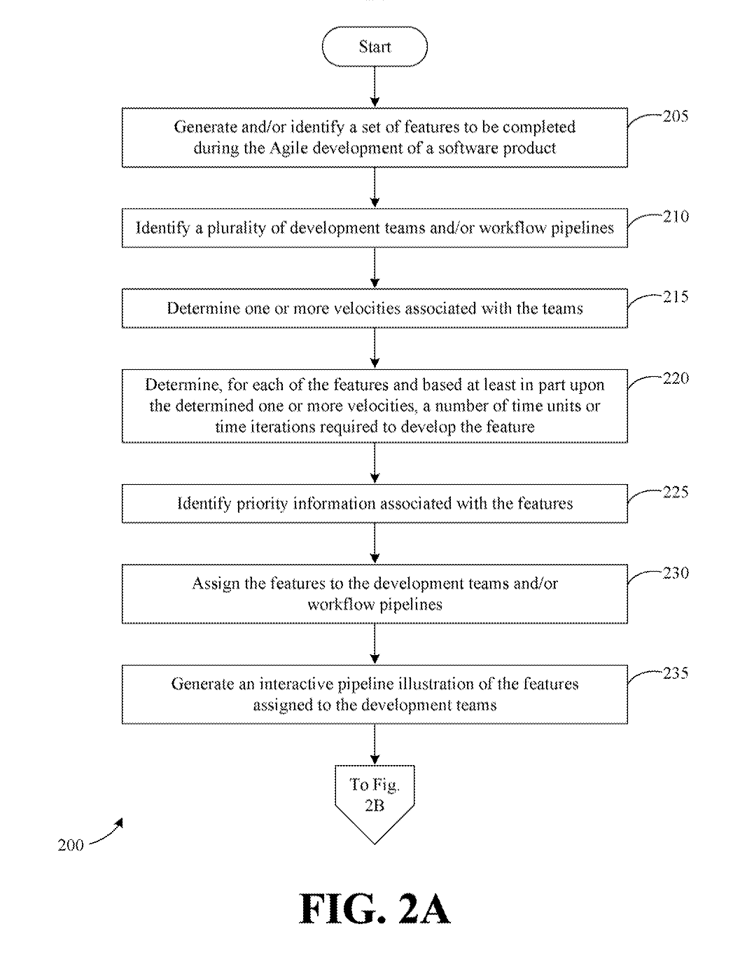

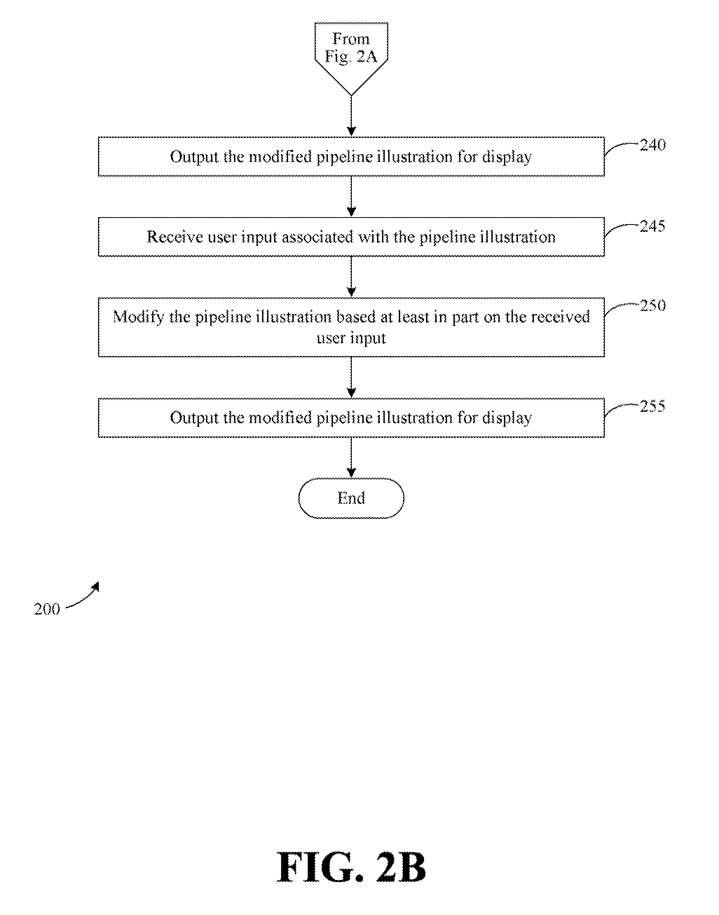

One example of the operations that may be performed by the development management module 136 is described in greater detail below with reference to FIGS. 2A and 2B.

With continued reference to FIG. 1, the network interface 128 may facilitate connection of the server computer 105 to the network(s) 145. In this regard, communication with other components of the system 100, such as the workstations 110 and/or the data sources 150 may be facilitated. As desired, any number of network cards (e.g., Ethernet cards) and/or other devices that facilitate network communications may be provided. The I/O interfaces 126 may facilitate communication between the server computer 105 and one or more input/output devices, for example, one or more user interfact devices, such as a display, keypad, mouse, pointing device, control panel, touch screen display, remote control, microphone, speaker, etc., that facilitate user interaction with the server computer 105. In this regard, user commands may be received by the server computer 105 and/or information, such as one or more generated illustrations, may be output by the server computer 105 for display.

As desired, any number of workstation 110 may be utilized in association with the system 100. A workstation 110 may be a suitable computing device or processor-driven device that facilitates the display of an illustration to a user and/or the receipt of user input that is communicated to the server computer 105. Similar to the server computer 105, a workstation 110 may include any number of memory devices, processors, I/O interfaces, and/or network interfaces. Additionally, a workstation 110 may communicate with the server computer 105 via any -number of suitable networks, such as networks 145.

In operation, a workstation 110 may be configured to receive information associated with a generated illustration from the server computer 105, and the workstation 110 may further be configured to output the generated illustration for display to a user. For example, the illustration may be formatted for display via a suitable display device (e.g., a monitor), and the illustration may be displayed utilizing the display device. The workstation 110 may further be configured to receive user input and/or user commands associated with the generation of an illustration and/or the modification of an illustration via any number of suitable user input devices (e.g., a keyboard, a mouse, a touch screen display, etc.). Once receive, user input and/or commands may be communicated by the workstation 110 to the server computer 105.

Additionally, any number of data sources 150 may be provided as desired in various embodiments of the invention. A data source 150 may be a suitable computing device or processor-driven device that facilitates the provision of information to a server computer 105 that may be utilized to generate an illustration that facilitates the management of a software development product. Similar to the server computer 105, a data source 150 may include any number of memory devices, processors, I/O interfaces, and/or network interfaces. Additionally, a data source 150 may communicate with the server computer 105 via any number of suitable networks, such as networks 145.

A wide variety of information may be provided to the server computer 105 by a data source 150 as desired in various embodiments of the invention, such as requirements data associated with a software product under development, specification data for a software product, historical requirements data associated with the software product and/or other software products, data utilized to calculate one or more development team velocities, other historical data, etc.

With continued reference to FIG. 1, the one or more illustrated networks 145 may include any suitable network or combination of networks that facilitate communications between the server computer 105, the workstations 110, and/or the data sources 150. Examples of suitable networks include, but are not limited to, a local area network, a wide area network, the Internet, a radio frequency (RF) network, a Bluetooth™ enabled network, a cellular network, any suitable wired network, any suitable wireless network, or any suitable combination of wired and wireless networks.

As desired, embodiments of the invention may include a system 100 with more or less than the components illustrated in FIG. 1. The system 100 of FIG. 1 is provided by way of example only.

FIGS. 2A-2B illustrate flow charts of one example method 200 for facilitating the visual management of an Agile development process, according to an illustrative embodiment of the invention. Operations of the method 200 may be performed by a suitable server computer, such as the server computer 105 illustrated in FIG. 1. The method may begin at block 205.

At block 205, a set or plurality of features to be completed during the Agile development process of a software product may be generated and/or identified. Each of the features may represent a component of the software product that is being development. As desired, a wide variety of suitable techniques may be utilized to identify a plurality of features. For example, features may be identified or generated utilizing a specification or requirements information associated with the software product. As another example, features may be identified and/or generated based upon historical information associated with previous versions of the software product and/or the development of similar or related software products. As yet another example, features may be manually identified by one or more users.

At block 210, a plurality of development teams that are available for the development of the software product may be identified. Any number of development teams may be identified as desired in various embodiments of the invention. Additionally, any number of work streams or work pipelines may be associated with each of the development teams and identified at block 210. For example, each of a plurality of development teams may be associated with a primary work pipeline, a secondary work pipeline, and a support pipeline. As desired, percentages of the development team time that is allocated to each work stream may also be identified or determined.

At block 215, one or more velocities associated with the development teams may be identified. A velocity may be indicative of the throughput or productivity of a development. In certain embodiments, a velocity may be identified based upon user input or input received from an external system or application. As desired in other embodiments, a wide variety of techniques may be utilized in order to determine, obtain, or calculate a velocity. For example, historical productivity data associated with one or more development teams may be utilized to calculate and/or adjust one or more velocities associated with the development teams. As another example, one or more velocities may be manually entered by a user. Any number of velocities may be determined or identified as desired in various embodiments. in certain embodiments, a velocity may be determined for each of the development teams. In other embodiments, an average velocity for a portion or all of the development teams may be calculated or determined. Additionally, as desired, velocities for a plurality of different work streams may be determined. For example, a velocity of a development team may be utilized to determine respective velocities associated with a plurality of work streams associated with the development team.

At block 220, a number of time units or time iterations required or estimated for development of the various features may be determined or identified. The number of time units determined for a feature may reflect a period of time that is allocated for development of the feature. Additionally, each time unit may reflect a predetermined period of development time, such as one week, two weeks, etc. In one example embodiment, the time units or iterations allocated to each feature may be determined based at least in part on requirements data for the features and/or the determined one or more velocities. For example, an amount of work or effort (e.g., a number of man hours, etc.) required to develop a feature may be identified. A velocity (e.g., an estimated throughput of a development team or work stream) may then be utilized in conjunction with required effort in order to determine an amount of time to allocate to the development of the feature. A number of predetermined time units or iterations to facilitate the development may then be allocated or assigned to the feature. In another example embodiment, time units may be manually allocated to the features by one or more users.

At block 225, which may be optional in certain embodiments of the invention, priority information associated with one or more of the features may be identified. The priority information may be utilized in order to determine an order in which the features are to be developed. For example, the priority information may identify critical features and/or important features to be included in the software product and/or various releases of the software product. As another example, the priority information may identify features that are prerequisites to other features. At block 230, the features may be assigned to the one or more development teams and/or to any number of work streams and/or work pipelines associated with the development team(s). As desired, priority information, velocity information, and/or relationships between features (e.g., indications of similar features) may be taken into account during the assignment of features. In certain embodiments, the features may be dynamically assigned by the development management module 136. In other embodiments, the features may be manually assigned based upon user input.

At block 235, a pipeline illustration, such as an interactive pipeline illustration, may be generated. The illustration may depict the features that are assigned to each of the development teams and/or work pipelines. Additionally, the illustration may depict a wide variety of other information associated with the development of the software product, such as a number of time units assigned to each feature, an identifier (e.g., a feature name and/or version number) associated with each feature, one or more projected release dates, a current point in time, billing or cost code information associated with each feature, etc. Once the pipeline illustration has been generated, the pipeline illustration may be output for display at block 240.

In certain embodiments, the pipeline illustration may be an interactive illustration that may be utilized to receive user input, such as one or more user requests to modify one or more features. At block 245, user input associated with the pipeline illustration, such as a request to modify a feature, may be received. The pipeline illustration may then be modified based at least in part on the received user input at block 250, and the modified illustration may be output for display at block 255.

In one example embodiment, once user input associated with the illustration is received, the user input may be analyzed in order to determine a requested modification to the illustration. A designated feature to be modified may additionally be identified. The request may then be processed in order to modify the feature, and the illustration may be modified or updated in order to reflect the modification of the feature. In certain embodiments, one or more additional features may be dynamically modified based upon the modification of the designated feature. As one example modification, a request to increase the time units allocated to a feature may be received, and the allocated time units for the feature may be increased. Additionally, other features assigned to the development team and/or relevant work pipeline may be shifted based upon the modification of the designated feature. For example, features to be developed following development of the modified feature may be shifted to a subsequent point in time. As another example modification, a request to assign a feature to a different development team or work pipeline may be received, and the feature may be assigned to a new development team. Additionally, other features assigned to the new development team may be dynamically shifted and/or reassigned. Features assigned to the original development team may also be dynamically shifted. A wide variety of different types of user requests may be processed as desired in various embodiments of the invention. The requests described above are provided by way of example only.

The method 200 may end following block 255.

The operations described in the method 200 of FIG. 2 do not necessarily have to be performed in the order set forth in FIG. 2, but instead may be performed in any suitable order. Additionally, in certain embodiments of the invention, more or less than all of the elements or operations set forth in FIG. 2 may be performed.

FIG. 3 is an example illustration 300 that may be generated in accordance with various embodiments of the invention. With reference to FIG. 3, a plurality of development teams 305 are illustrated. Additionally, a plurality of work streams or work pipelines are associated with each development team. For example, a first development team has a primary work stream 310 and a secondary or extra work stream 315. Relatively high priority features or components may be assigned to primary work streams and lower priority features and/or ancillary features may be assigned to secondary work streams.

With continued reference to FIG. 3, the features that are assigned to each of the work streams are illustrated. For each feature, a time period that has been allocated to the feature is also illustrated. The time period represents a number of time units or time iterations that are allocated to the feature. In FIG. 3, a time unit of two weeks is utilized. Accordingly, for one example feature 320, ten time units have been assigned or time iterations have been assigned. Additionally, for each feature, an identifier of the feature (e.g., a feature name, feature version number, etc.) may be included in association with the feature. For example, an identifier 325 of the example feature 320 is included in the illustration 300. As desired, other information associated with each of the features may be included in the illustration 330. For example, billing information or cost center information that is indicative of a business unit or budget that is funding the development of a feature may be included. As one example, each of the features may be color coded in order to indicate billing information associated with the features.

Additionally, one or more release dates 330 may be included in the illustration 300. The release dates 330 may indicate points in time at which a release of the software product is expected. Any of the features that have been completed prior to a release date 330 may be included in the relevant release of the software product. Further, an identifier 335 or indicator of the current date or point in time within the development cycle may be included in the illustration 300. In this regard, the development of the various features may be viewed and/or managed.

In certain embodiments, the illustration 300 may be an interactive illustration that facilitates the receipt of user input. For example, a user may expand or reduce a number of time units (or partial time units) that are allocated to each of the features by selecting a projected end point for a feature and dragging the selected end point to a new location within the illustration 300. As another example, a user may reassign a feature to a different work pipeline or to a different point within a work pipeline by selecting the feature and dragging the feature to a new location. A wide variety of other user input may be facilitated as desired, for example, a modification of a release date, the addition of one or more new features, the deletion of one or more features, the addition and/or deletion of one or more development teams and/or work pipelines, etc.

The illustration 300 of FIG. 3 may facilitate a relatively high level management of an Agile software development process. The illustration 300 may facilitate visual management of the development teams assigned to a software product and the features assigned to the development teams. Additionally, the illustration 300 may facilitate the visual management of the completion of one or more features, while additionally displaying features that have previously been completed and/or features that are yet to be developed. In this regard, both features and/or the allocation of features may be managed during the development of a software product.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for displaying a set of features to be completed during development of a software product, the method comprising:
identifying, by a computing system, a plurality of features to be completed during an Agile development process for the software product;
determining, by the computing system, a respective number of predetermined time units to be allocated for development of each feature;
assigning, by the computing system based at least in part upon the determination of predetermined time units, each of the features to a respective development team included in a plurality of development teams;
generating, by the computing system, an illustration of the plurality of features assigned to the plurality of development teams, wherein the illustration comprises, for each feature, a respective identifier of the feature and a respective indication of the predetermined time units allocated to the feature; and
outputting, by the computing system for display to a user, the generated illustration.

2. The method of claim 1, wherein generating an illustration comprises generating an interactive illustration, and further comprising:
receiving, by the computing system, a user request to modify a designated feature included in the illustration;
modifying, by the computing system based upon the received user request, the designated feature;
modifying, by the computing system, the illustration to reflect the modification of the designated feature; and
outputting, by the computing system for display to the user, the modified illustration.

3. The method of claim 2, wherein receiving a user request to modify a designated feature comprises receiving one of (i) a request to modify a priority associated with the designated feature, (ii) a request to modify the number of time units associated with the designated feature, or (iii) a request to assign the designated feature to another development team.

4. The method of claim 2, further comprising:
dynamically modifying, by the computing system based upon the modification of the designated feature, one or more additional features other than the designated feature.

5. The method of claim 1, further comprising:
identifying, by the computing system, priority information associated with the plurality of features,
wherein assigning the features comprises assigning the features based at least in part upon the identified priority information.

6. The method of claim 1, further comprising:
determining, by the computing system, a velocity associated with the plurality of development teams,
wherein determining, for each of the features, a respective number of predetermined time units to be allocated comprises determining based at least in part upon the determined velocity.

7. The method of claim 6, wherein determining a velocity comprises:
determining, by the computing system, a respective velocity associated with each of the plurality of development teams; and
determining, by the computing system utilizing the determined respective velocities, an average velocity.

8. The method of claim 1, wherein generating an illustration comprises generating an illustration including (i) one or more release dates associated with the software products and (ii) an indication of a current point in time within the development process.

9. The method of claim 1, further comprising:
identifying, by the computing system for each of the plurality of development teams, one or more respective workflow pipelines,
wherein assigning each of the features comprises assigning each of the features to a respective workflow pipeline.

10. The method of claim 9, further comprising:
identifying, by the computing system for each of the one or more workflow pipelines, a percentage of workload for the associated development team to be assigned to the pipeline,
wherein determining a respective number of predetermined time units to be allocated comprises determining a respective number of time units based upon the identified percentages.

11. A system for displaying a set of features to be completed during development of a software product, the system comprising:
at least one memory configured to store computer-executable instructions; and
at least one processor configured to access the, at least one memory and execute the computer-executable instructions to:
identify a plurality of features to be completed during an Agile development process for the software product;
determine a respective number of predetermined time units to be allocated for development of each feature;
assign, based at least in part upon the determination of predetermined time units, each of the features to a respective development team included in a plurality of development teams;
generate an illustration of the plurality of features assigned to the plurality of development teams, the illustration comprising, for each feature, a respective identifier of the feature and a respective indication of the predetermined time units allocated to the feature; and
direct the output of the generated illustration for display to a user.

12. The system of claim 11, wherein the illustration comprises an interactive illustration, and the at least one processor is further configured to execute the computer-executable instructions to:
receive a user request to modify a designated feature included in the illustration;
modify, based upon the received user request, the designated feature;
modify the illustration to reflect the modification of the designated feature; and
direct the output of the modified illustration for display to the user.

13. The system of claim 12, wherein the user request comprises one of (i) a request to modify a priority associated with the designated feature, (ii) a request to modify the number of time units associated with the designated feature, or (iii) a request to assign the designated feature to another development team.

14. The system of claim 12, wherein the at least one processor is further configured to execute the computer-executable instructions to dynamically modify, based upon the modification of the designated feature, one or more additional features other than the designated feature.

15. The system of claim 11, wherein the at least one processor is further configured to execute the computer-executable instructions to:
identify priority information associated with the plurality of features; and
assign the features based at least in part upon the identified priority information.

16. The system of claim 11, wherein the at least one processor is further configured to execute the computer-executable instructions to:
determine a velocity associated with the plurality of development teams; and
determine, for each of the features, the respective number of predetermined time units to be allocated based at least in part upon the determined velocity.

17. The system of claim 16, wherein the determine velocity comprises an average velocity calculated from a respective velocity associated with each of the plurality of development teams.

18. The system of claim 11, wherein the illustration includes (i) one or more release dates associated with the software products and (ii) an indication of a current point in time within the development process.

19. The system of claim 11, wherein the at least one processor is further configured to execute the computer-executable instructions to:
identify, for each of the plurality of development teams, one or more respective workflow pipelines; and
assign each of the features to a respective workflow pipeline.

20. The system of claim 19, wherein the at least one processor is further configured to (i) identify, for each of the one or more workflow pipelines, a percentage of workload for the associated development team to be assigned to the pipeline, and (ii) determine the respective number of predetermined time units to be allocated based upon the identified percentages.
